(19) United States
(12) Patent Application Publication
(10) Pub. No.: US 2013/0085623 A1
(43) Pub. Date: Apr. 4, 2013

(54) POWER SUPPLY DEVICE AND CONTROL METHOD THEREFOR

(71) Applicants: Naotoku Izumisawa, Yamato-shi (JP); Yohichi Miwa, Yokohama-shi (JP); Manabu Saitoh, Sagamihara-shi (JP)

(72) Inventors: Naotoku Izumisawa, Yamato-shi (JP); Yohichi Miwa, Yokohama-shi (JP); Manabu Saitoh, Sagamihara-shi (JP)

(73) Assignee: INTERNATIONAL BUSINESS MACHINES CORPORATION, Armonk, NY (US)

(21) Appl. No.: 13/567,190

(22) Filed: Aug. 6, 2012

(30) Foreign Application Priority Data
Sep. 29, 2011 (JP) 2011-214189

(51) Int. Cl. G06F 1/26

(52) U.S. Cl. 700/297

(57) ABSTRACT

A power supply device includes two or more power supply units connected in parallel with each other, each of which includes a rectifier for converting DC power from a DC power source or AC power from an AC power source into predetermined rated DC power. The device further includes a sensor for detecting a load current rate of each of the power supply units, and a controller. The controller controls the operation of the power supply units to reduce the total amount of power consumption per power supply unit calculated based on the rated DC power and the efficiency of each of the power supply units corresponding to the load current rate. As a result, the power consumption of the power supply device can be reduced more appropriately according to the load state and the efficiency of the power supply units.

### CROSS-REFERENCE TO RELATED APPLICATIONS

This application claims priority under 35 U.S.C. §119 to Japanese Patent Application No. 2011-214189 filed on Sep. 29, 2011, the entire text of which is specifically incorporated by reference herein.

### BACKGROUND OF THE INVENTION

1. Field of the Invention

The present invention relates to a power supply device and a control method therefor, and relates more specifically to operation control of two or more power supply units, each of which converts DC power or AC power to predetermined rated DC power.

2. Background of the Related Art

The power supply for a server or the like uses a redundant power supply configuration to improve the reliability. Here, the redundant power supply configuration means a configuration including at least two power supply units having the same rated output (W) and capable of switching between operation with the redundant power supply configuration (two or more power supply units) and operation with one power supply unit depending on the situation. Each power supply unit converts AC power from an AC power source into predetermined rated DC power.

For example, even if a power supply device having an efficiency of about 90%, which is generally perceived to be highly efficient, is used, 10% of power will be consumed by the power supply device itself due to power loss. This results in 10% power loss in the power consumption of the server, which corresponds to a very large amount of power loss over the entire data center including multiple servers.

Therefore, for example, in order to pursue low power consumption at the entire data center, it is desired to reduce the power consumption of the power supply device (power supply unit) itself as much as possible.

### BRIEF SUMMARY OF THE INVENTION

One embodiment of the present invention provides a power supply device, comprising two or more power supply units connected in parallel with each other, each of which includes a rectifier for converting DC power from a DC power source or AC power from an AC power source into predetermined rated DC power. The power supply device further comprises a sensor for detecting a load current rate of each of the power supply units, and a controller for controlling operation of the power supply units to reduce a total amount of power consumption per power supply unit calculated based on the predetermined rated DC power and the efficiency of each of the power supply units corresponding to the load current rate.

Another embodiment of the present invention provides a method for controlling a power supply device including two or more power supply units connected in parallel with each other, wherein each power supply unit includes a rectifier for converting DC power from a DC power source or AC power from an AC power source into predetermined rated DC power. The method comprises preparing a map representing a relationship between a load current rate of each of the power supply units and a difference value between the power consumption corresponding to the load current rate upon operation of one power supply unit and the power consumption corresponding to the load current rate upon parallel operation of two or more power supply units. The method further comprises setting, from the map, a reference load-current rate as a reference for switching between the operation of one power supply unit and the parallel operation of two or more power supply units. The method then detects the load current rate of the power supply unit, compares the detected load current rate with the reference load-current rate, and switches between the operation of one power supply unit and the parallel operation of two or more power supply units.

Yet another embodiment of the present invention provides a computer program product including computer usable program code embodied on a computer usable medium for controlling a power supply device including two or more power supply units connected in parallel with each other, wherein each power supply unit includes a rectifier for converting DC power from a DC power source or AC power from an AC power source into predetermined rated DC power. The computer program product includes: computer usable program code for preparing a map representing a relationship between a load current rate of each of the power supply units and a difference value between the power consumption corresponding to the load current rate upon operation of one power supply unit and the power consumption corresponding to the load current rate upon parallel operation of two or more power supply units; computer usable program code for setting, from the map, a reference load-current rate as a reference for switching between the operation of one power supply unit and the parallel operation of two or more power supply units; computer usable program code for detecting the load current rate of the power supply unit; computer usable program code for comparing the detected load current rate with the reference load-current rate; and computer usable program code for switching between the operation of one power supply unit and the parallel operation of two or more power supply units.

### BRIEF DESCRIPTION OF THE SEVERAL VIEWS OF THE DRAWINGS

FIG. 1 is a diagram showing the configuration of a power supply device according to the present invention.

FIG. 2 is a chart showing an example of the relationship between a load current rate and the efficiency of a power supply unit.

FIG. 3 is a chart showing the relationship between the load current rate and a power consumption difference.

FIG. 4 is a chart showing the relationship between the load current rate and the efficiency of a power supply unit.

FIG. 5 is a chart showing the relationship between the load current rate and a power consumption difference.

FIG. 6 is a flowchart showing a control flow of the power supply device of the present invention.

### DETAILED DESCRIPTION OF THE INVENTION

One embodiment of the present invention provides a power supply device. The power supply device includes two or more power supply units connected in parallel with each other. Each of the two or more power supply units includes a rectifier for converting DC power from a DC power source or AC power from an AC power source into predetermined rated DC power. The power supply device also includes a sensor for detecting a load current rate of each of the power supply units and a controller for controlling the operation of the power supply units to reduce the total amount of power consumption per power supply unit calculated based on the predetermined rated DC power and the efficiency of each of the power supply units corresponding to the load current rate.

Embodiments of the present invention reduce the power consumption of a power supply device without impairing redundancy and reliability in a redundant power supply configuration. Since the operation of the power supply units is controlled to reduce the total amount of power consumption per power supply unit calculated based on the rated DC power and the efficiency of each of the power supply units corresponding to the load current rate, the power consumption of the power supply device can be reduced more appropriately according to the load state and the efficiency of the power supply units.

In one embodiment of the present invention, the power supply device further includes a storage device for storing a map representing the relationship between the load current rate and a difference value between the power consumption corresponding to the load current rate upon operation of one power supply unit and the power consumption corresponding to the load current rate upon parallel operation of two or more power supply units, wherein the controller sets, from the map, a reference load-current rate as a reference for switching between the operation of one power supply unit and the parallel operation of two or more power supply units to switch between the operation of one power supply unit and the parallel operation of two or more power supply units according to a comparison result between the detected load current rate and the reference load-current rate. An operation state (i.e., the operation of one power supply unit or the simultaneous operation of two or more power supply units) with less power consumption can be adopted quickly based on the detected load current rate.

In another embodiment of the present invention, the reference load-current rate has a first reference load-current rate and a second reference load-current rate greater than the first reference load-current rate. Then, the controller adopts the parallel operation of two or more power supply units (“two-unit operation”) in response to the detected load current rate becoming greater than the second reference load-current rate during the operation of one power supply unit, or adopts the operation of one power supply unit (“one-unit operation”) in response to the detected load current rate becoming less than the first reference load-current rate during the parallel operation of two or more power supply units. Since the reference load-current rate for switching between the operation of one power supply unit and the parallel operation of two or more power supply units has a predetermined range (a difference between the first reference load-current rate and the second reference load-current rate), the switching timing can have a predetermined delay even if the load current rate varies frequently in a short time, i.e., hysteresis characteristics are provided, thereby preventing trouble from developing on the load side due to an unstable supply of power.

In still another embodiment of the present invention, when performing the one-unit operation, the controller performs the operation of each power supply unit while switching between selected two power supply units at a predetermined timing. Since the operation of each power supply unit is performed while switching between selected two power supply units at a predetermined timing, there is a reduction in the adverse impact of continuous operation of only a specific power supply unit for a long period of time, which deteriorates parts by heat generation and hence shortens the life of the power supply unit.

In yet another embodiment of the present invention, the power supply device further includes either or both of a charger provided on an output stage of the two or more power supply units and an uninterruptible power supply (UPS) provided in parallel with the two or more power supply units. In these embodiments, power can be supplied stably even at the time of switching to a power supply unit to be operated or upon occurrence of a sudden event. This can further increase the redundancy and reliability of the power supply device.

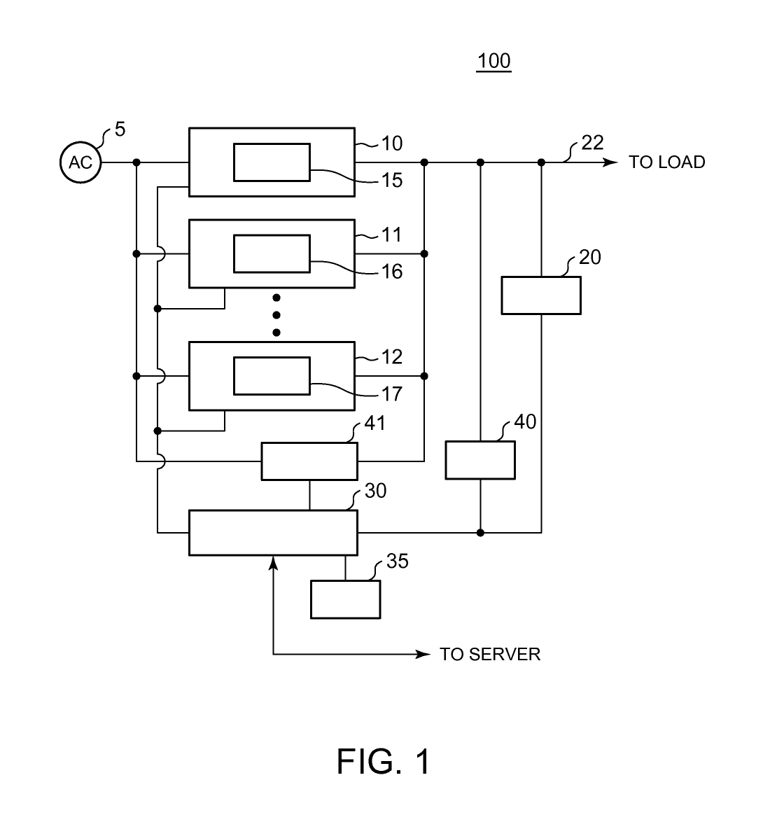

A preferred embodiment of the present invention will be described with reference to the accompanying drawings. FIG. 1 is a diagram showing the configuration of a power supply device of the present invention. A power supply device 100 includes power supply units 10, 11, and 12, sensor 20, controller 30, storage device 35, a charger 40, and an uninterruptible power supply (UPS) 41. The storage device 35 may be incorporated in the controller 30. The charger 40 and the uninterruptible power supply (UPS) 41 are not indispensable elements, but it is preferable to include them in the power supply device if possible. The controller 30 can communicate with a host such as a server. As a load in FIG. 1, there can be any system, apparatus, or device, such as the server.

The power supply units 10, 11, and 12 are connected in parallel with each other, each including a rectifier 15, 16, and 17, respectively, for converting AC power from an AC power source 5 to predetermined rated DC power. The AC power source 5 includes commercial AC power (voltage) such as 100 V, 115 V, or 230 V. The predetermined rated DC power includes DC power with any voltage required by the load, such as 12 V or 15 V. DC power from a DC power source can be used instead of the AC power from the AC power source 5. In other words, the present invention can be applied in the same way to a case where input power is DC power. Further, three power supply units 10, 11, and 12 are shown in FIG. 1, but the number of power supply units is not limited to three as long as the number is two or more. Basically, the two or more power supply units output the same predetermined rated DC power and are so configured that, if one power supply unit is broken down, the other can continue to supply (back up) the same rated DC power. In this application, the power supply configuration having this redundancy is also called a redundant power supply configuration. In the example of FIG. 1, any two power supplies (e.g., 10 and 12) or all three power supplies can be selected from the three power supply units 10, 11, and 12 as the redundant power supply configuration.

The sensor 20 detects the load current rate of each of the power supply units 10, 11, and 12. In FIG. 1, the sensor 20 is connected to an output line 22 of the power supply units, but the sensor may be configured to be connected directly to an output stage inside each power supply unit, respectively. Here, the load current rate α means the ratio of load current I to the maximum rated load current value Im of the power supply unit (α=I/Im). Specifically, the sensor 20 detects current through the output line 22 or the output current of the power supply units, and divides the load current value by the maximum rated load current value Im to calculate the load current rate α. The sensor 20 may serve as a type of ammeter to detect only the current value so that the controller 30 will calculate the load current rate α.

The controller 30 controls the operation of the power supply units to reduce the total amount of power consumption per power supply unit calculated based on the rated DC power of the power supply units and the efficiency of each power supply unit corresponding to the load current rate. Here, efficiency β of a power supply unit means the ratio of output power Po to input power Pi of the power supply unit (β=Po/Pi). The higher the efficiency β, the less the power consumption of the power supply unit itself. Power consumption P of each power supply unit is calculated by using the following equation (1):

P=Pc·α/(n·β) (1),

where Pc denotes rated DC power, α is a load current rate, n is the number of power supply units, and β is the efficiency of each power supply unit. Note that the above equation (1) is an effective equation when the sensor 20 calculates the current value of the output line 22 to calculate the load current rate α. If the sensor 20 is connected directly to the output stage of each power supply unit, calculations will be made by using n=1 (fixed value).

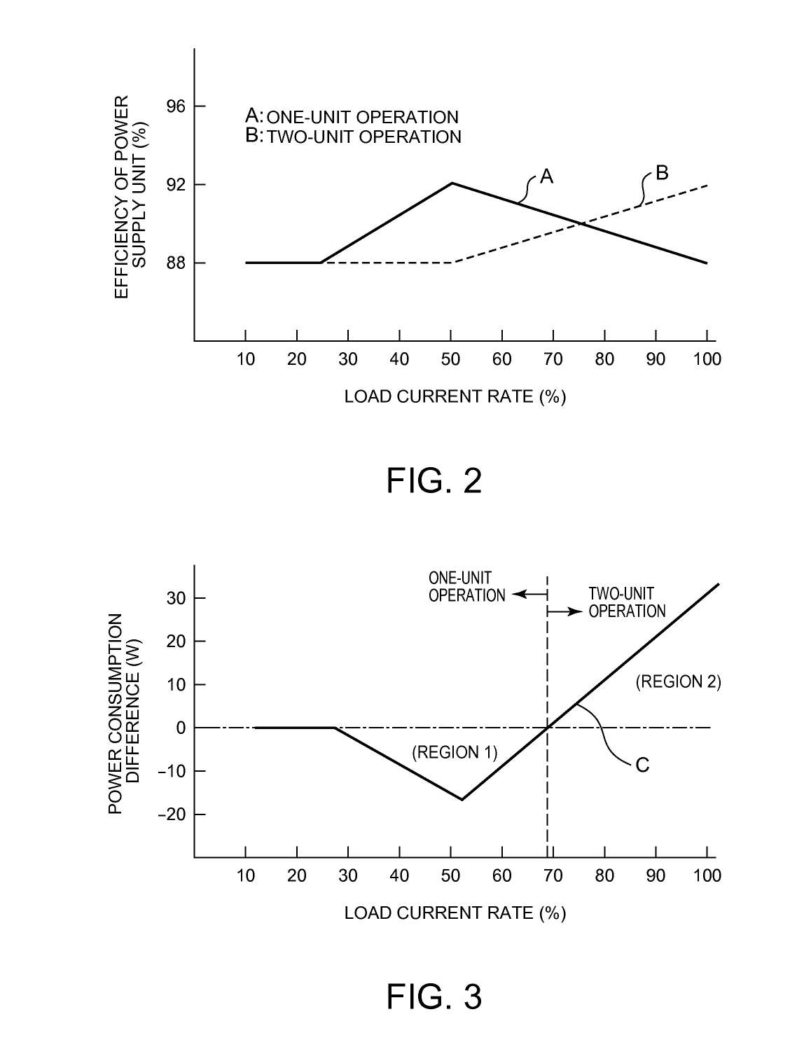

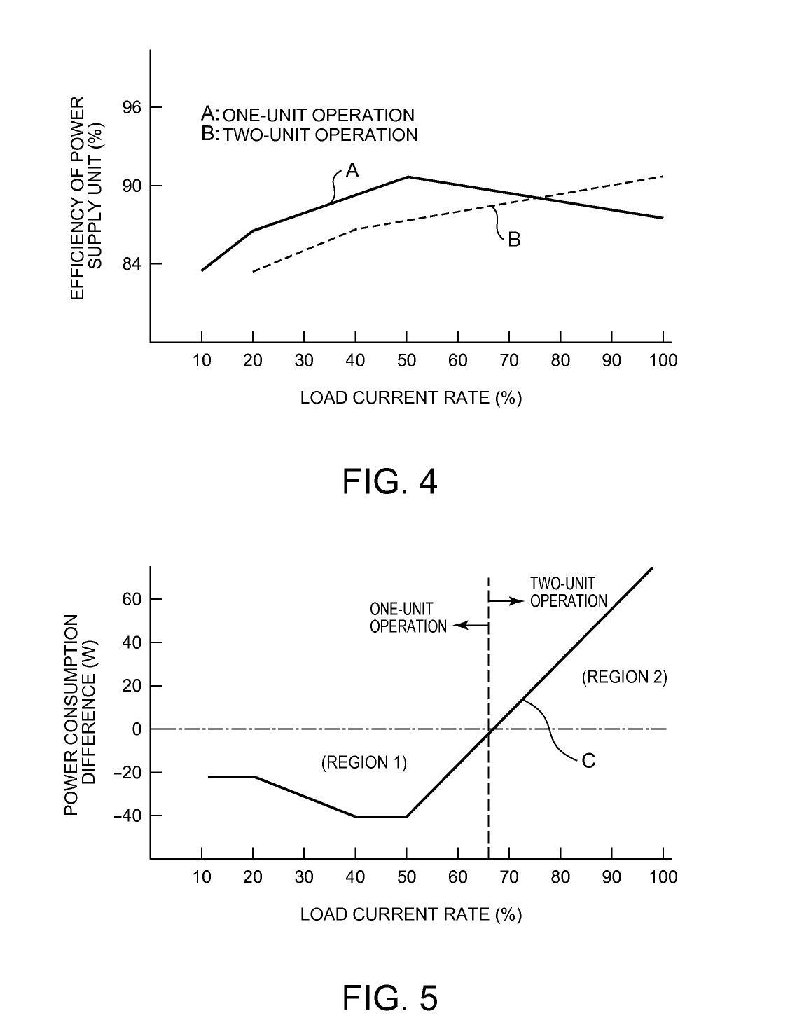

FIG. 2 and FIG. 4 show examples of relationships between the load current rate and the efficiency of a power supply unit. FIG. 2 shows the efficiency of a power supply unit when the rated DC power is 675 W with an AC input of 115 V. FIG. 4 shows the efficiency of a power supply unit when the rated DC power is 2500 W with the AC input of 115 V. In both figures, graph A indicates efficiency when one power supply unit is operated, and graph B indicates efficiency per unit when two power supply units are operated.

In FIG. 2, efficiency (A) in the case of one-unit operation is turned to decline and efficiency (B) per unit in the case of two-unit operation is turned to increase with as the load current rate exceeds 50%. Then, efficiency (B) is greater than efficiency (A) at load current rates greater than 75%.

In FIG. 4, efficiency (A) in the case of one-unit operation is turned to decline as the load current rate exceeds 50%, while efficiency (B) per unit in the case of two-unit operation increases with increasing load current rate. As in the case of FIG. 2, FIG. 4 shows that the efficiency (B) becomes greater than efficiency (A) at load current rates greater than about 75%. Thus, considering the efficiency of a power supply unit, either the operation of one power supply unit will be better in efficiency than the operation of two or more power supply units, or the redundant power supply operation (two-unit operation) will be better in efficiency than the operation of one power supply unit, depending on the load state.

The storage device 35 stores a map representing the relationship between the load current rate and a difference value between the power consumption corresponding to the load current rate upon operation of one power supply unit and the power consumption corresponding to the load current rate upon parallel operation of two or more power supply units. FIG. 3 and FIG. 5 show examples of relationships between the load current rate and a power consumption difference. FIG. 3 corresponds to FIG. 2, corresponding to a map for power supply units with an AC input of 115 V and a rated DC power of 675 W. FIG. 5 corresponds to FIG. 4, corresponding to a map for power supply units with an AC input of 115 V and a rated DC power of 2500 W. In both of FIG. 3 and FIG. 5, the power consumption difference on the vertical axis indicates a difference value (P1−P2) between power consumption P1 when one power supply unit is operated and power consumption P2 when two power supply units are operated. The power consumption is calculated by the above equation (1).

From the map illustrated in FIG. 3 or FIG. 5, the controller 30 sets a reference load-current rate as a reference for switching between operation of one power supply unit and parallel operation of two or more power supply units to switch between the operation of one power supply unit and the parallel operation of two or more power supply units according to the comparison result between the detected load current rate and the reference load-current rate. Specifically, this is done as follows:

In FIG. 3, the difference value (P1−P2) reverses near 68% of load current rate. In other words, the difference value (P1−P2) is negative below 68% of load current rate or less (region 1), and this means that the power consumption P1 when one power supply unit is operated is smaller than the power consumption P2 when two power supply units are operated. On the other hand, the difference value (P1−P2) becomes positive above 68% of load current rate or more (region 2), and this means that the power consumption P1 is larger than the power consumption P2, i.e., P2 becomes smaller. Therefore, the controller 30 sets 68% of load current rate as the reference load-current rate to operate one power supply unit at the reference load-current rate of 68% or less or operate in the redundant power supply configuration (operation of two or more power supply units) at the reference load-current rate of 68% or more, enabling reduction in power consumption.

Taking the map in FIG. 5, for example, the difference value (P1−P2) reverses near 65% of load current rate. In other words, the difference value (P1−P2) is negative at 65% of load current rate or less (region 1), and this means that the power consumption P1 when one power supply unit is operated is smaller than the power consumption P2 when two power supply units are operated. On the other hand, the difference value (P1−P2) becomes positive at 65% of load current rate or more (region 2), and this means that the power consumption P1 is larger than the power consumption P2, i.e., P2 becomes smaller than P1. Therefore, the controller 30 sets 65% of load current rate as the reference load-current rate to operate one power supply unit at the reference load-current rate of 65% or less or operate in the redundant power supply configuration (two units) at the reference load-current rate of 65% or more, enabling reduction in power consumption.

As reference load-current rates, a first reference load-current rate and a second reference load-current rate larger than the first reference load-current rate may be set. Taking the case in FIG. 3, for example, the first reference load-current rate may be set to 65% and the second reference load-current rate may be set to 71%. In this case, during operation of one power supply unit, when the detected load current rate becomes larger than the second reference load-current rate (71%), the controller 30 adopts parallel operation of two units. On the other hand, during the parallel operation of two units, when the detected load current rate becomes smaller than the first reference load-current rate (65%), the controller 30 adopts the one-unit operation.

Thus, providing a predetermined range (e.g., a difference of 6% between the first reference load-current rate of 65% and the second reference load-current rate of 71%) for the reference load-current rate (e.g., 68%) for switching between the operation of one power supply unit and the parallel operation of two or more power supply units can delay the switching timing even if the load current rate varies frequently in a short time, i.e., provide hysteresis characteristics, thereby preventing trouble from developing on the load side due to an unstable supply of power.

When performing the one-unit operation, the controller 30 can also control the operation of each unit while switching between selected two power supply units at a predetermined timing. For example, in the power supply device shown in FIG. 1, the controller 30 can control switching alternately between the selected power supply units 10 and 12, or 11 and 12, or switching among three units in turn at predetermined timings. This can lead to a reduction in the adverse impact of continuous operation of only a specific power supply unit for a long period of time, which can deteriorate parts by heat generation and hence shorten the life of the power supply unit. In a situation difficult to switch between operations, or when any one unit is selectable from multiple power supply units, a power supply unit with the minimum power consumption can be operated.

The charger 40 provided on the output stage 22 of the power supply units in FIG. 1 or the uninterruptible power supply (UPS) 41 provided in parallel with the power supply units is provided to supply power stably even at the time of switching to a power supply unit to be operated or upon occurrence of a sudden event. This can further increase the redundancy of the power supply device. The charger 40 includes a capacitor, a battery, and the like. In addition to the use of the charger (capacitor and the like) only on the output stage 22 of the power supply units, a charger (capacitor and the like) can also be used at a standby power supply output (AUX power supply output) or the like normally provided for a power supply unit so that the power source or circuit of power supply units to stand by (to be turned off) in the configuration of one power supply unit will be turned off, thereby achieving lower power consumption.

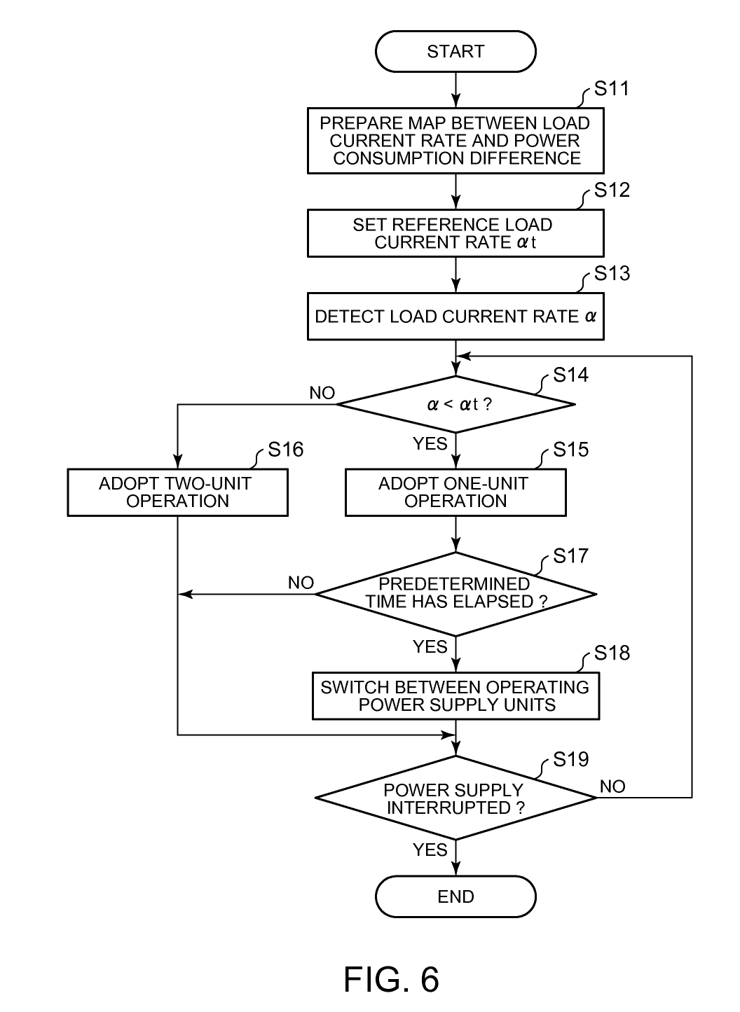

Referring next to FIG. 6, a basic control flow of the power supply device of the present invention will be described. The control flow in FIG. 6 is executed by the power supply device, mainly by the controller 30 in FIG. 1.

In step S11, a map is prepared, where the map represents the relationship between the load current rate of each power supply unit and a difference value between the power consumption corresponding to the load current rate upon operation of one power supply unit and the power consumption corresponding to the load current rate upon parallel operation of two or more power supply units. This map is as described above with reference to FIG. 3 and FIG. 5. In step S12, from the map, a reference load-current rate αt is set as a reference for switching between the operation of one power supply unit and the parallel operation of two or more power supply units. The setting of this reference load-current rate αt is as described in detail above. As mentioned above, the first and second reference load-current rates may be set as reference load-current rates at.

In step S13, the load current rate α of a power supply unit is detected. The details of the detection of this load current rate α are as described above. In step S14, it is determined whether the detected load current rate α is smaller than the reference load-current rate αt. Specifically, for example, it is determined whether the load current rate α is smaller than the reference load-current rate of 68% (65%) in FIG. 3 (FIG. 5) mentioned above. When this determination is Yes, the operation of one power supply unit is adopted in step S15, because the power consumption can be reduced. When the determination is No, the operation (redundant configuration) of two power supply units is adopted in step S16, because the power consumption can be reduced as well. As mentioned above, a magnitude relationship between the first and second reference load-current rates may be determined in step S14.

In step S17, it is determined whether a predetermined period of time has elapsed since the operation of one power supply unit was adopted. When this determination is “Yes”, the power supply unit to be operated is switched to the other or another selected unit in step S18. As mentioned above, this is to reduce the damage of parts deterioration caused by heat generation and hence shortening the life of the power supply unit. Then, in step S19, it is determined whether the power supply by the power supply device is to be interrupted. The procedure will return to step S14 so long as this determination is “No”, and steps S14 to S18 are repeated.

While the embodiment of the present invention is described with reference to the accompanying drawings, the present invention is not limited to the embodiment. For example, the aforementioned embodiment mostly describes the cases of the operation of one power supply unit and the operation of the redundant configuration (two units), but the present invention is not limited thereto. It goes without saying that the present invention is applicable to a redundant configuration of three or more power supply units or any number of power supply units. Further, instead of deriving power consumption P of a power supply unit from Equation (1), voltage and current may be measured in an AC power input portion and a DC power output portion of the power supply device 10 to calculate actual power P using the measured voltage and current. It should be noted that the present invention can be carried out in other modes to which various improvements, modifications, and changes are added based on the knowledge possessed by those skilled in the art without departing from the spirit of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A power supply device, comprising:
two or more power supply units connected in parallel with each other, each of which includes a rectifier for converting DC power from a DC power source or AC power from an AC power source into predetermined rated DC power;
a sensor for detecting a load current rate of each of the power supply units; and
a controller for controlling operation of the power supply units to reduce a total amount of power consumption per power supply unit calculated based on the predetermined rated DC power and the efficiency of each of the power supply units corresponding to the load current rate.

2. The power supply device of claim 1, further comprising:
a storage device for storing a map representing a relationship between the load current rate and a difference value between the power consumption corresponding to the load current rate upon operation of one power supply unit and the power consumption corresponding to the load current rate upon parallel operation of two or more power supply units,
wherein the controller sets, from the map, a reference load-current rate as a reference for switching between the operation of one power supply unit and the parallel operation of two or more power supply units to switch between the operation of one power supply unit and the parallel operation of two or more power supply units according to a comparison result between the detected load current rate and the reference load-current rate.

3. The power supply device of claim 2, wherein the controller adopts the operation of one power supply unit in response to the detected load current rate being less than the reference load-current rate, and wherein the controller adopts the parallel operation of two or more power supply units in response to the detected load current rate being greater than the reference load-current rate.

4. The power supply device of claim 2, wherein the reference load-current rate includes a first reference load-current rate and a second reference load-current rate greater than the first reference load-current rate, and
wherein the controller adopts the parallel operation of two or more power supply units in response to the detected load current rate becoming greater than the second reference load-current rate during the operation of one power supply unit, or adopts the one power supply unit operation in response to the detected load current rate becoming less than the first reference load-current rate during the parallel operation of two or more power supply units.

5. The power supply device of claim 3, wherein when performing the one-unit operation, the controller performs the operation of each power supply unit while switching between selected two power supply units at a predetermined timing.

6. The power supply device of claim 2, wherein when performing the operation of one power supply unit, the controller operates a power supply unit with minimum power consumption per power supply unit.

7. The power supply device of claim 1, further comprising:
either or both of a charger provided on an output stage of the two or more power supply units and an uninterruptible power supply (UPS) provided in parallel with the at least two or more power supply units.

8. The power supply device of claim 1, wherein power consumption (P) per power supply unit is calculated by using the following equation:
P=Pc·α/(n·β),
where Pc denotes rated DC power, α is a load current rate, n is the number of power supply units, and β is efficiency of each power supply unit.

9. A method for controlling a power supply device including two or more power supply units connected in parallel with each other, wherein each power supply unit includes a rectifier for converting DC power from a DC power source or AC power from an AC power source into predetermined rated DC power, the method comprising:
preparing a map representing a relationship between a load current rate of each of the power supply units and a difference value between the power consumption corresponding to the load current rate upon operation of one power supply unit and the power consumption corresponding to the load current rate upon parallel operation of two or more power supply units;
setting, from the map, a reference load-current rate as a reference for switching between the operation of one power supply unit and the parallel operation of two or more power supply units;
detecting the load current rate of the power supply unit;
comparing the detected load current rate with the reference load-current rate; and
switching between the operation of one power supply unit and the parallel operation of two or more power supply units.

10. The method according to claim 9, wherein the reference load-current rate includes a first reference load-current rate and a second reference load-current rate larger than the first reference load-current rate, and
wherein the step of switching between the operations includes adopting the parallel operation of two or more power supply units in response to the detected load current rate becoming greater than the second reference load-current rate during the operation of one power supply unit, or adopting the operation of one power supply unit in response to the detected load current rate becoming less than the first reference load-current rate during the parallel operation of two or more power supply units.

11. The method according to claim 9, further comprising:
performing the operation of each power supply unit while switching between selected two power supply units at a predetermined timing when the operation of one power supply unit is performed.

12. A computer program product including computer usable program code embodied on a computer usable medium for controlling a power supply device including two or more power supply units connected in parallel with each other, wherein each power supply unit includes a rectifier for converting DC power from a DC power source or AC power from an AC power source into predetermined rated DC power, the computer program product including:
computer usable program code for preparing a map representing a relationship between a load current rate of each of the power supply units and a difference value between the power consumption corresponding to the load current rate upon operation of one power supply unit and the power consumption corresponding to the load current rate upon parallel operation of two or more power supply units;
computer usable program code for setting, from the map, a reference load-current rate as a reference for switching between the operation of one power supply unit and the parallel operation of two or more power supply units;
computer usable program code for detecting the load current rate of the power supply unit;
computer usable program code for comparing the detected load current rate with the reference load-current rate; and
computer usable program code for switching between the operation of one power supply unit and the parallel operation of two or more power supply units.

13. The computer program product of claim 12, wherein the reference load-current rate includes a first reference load-current rate and a second reference load-current rate larger than the first reference load-current rate, and
wherein the computer usable program code for switching between the operation of one power supply unit and the parallel operation of two or more power supply units includes computer usable program code for adopting the parallel operation of two or more power supply units in response to the detected load current rate becoming greater than the second reference load-current rate during the operation of one power supply unit, or adopting the operation of one power supply unit in response to the detected load current rate becoming less than the first reference load-current rate during the parallel operation of two or more power supply units.

14. The computer program product of claim 12, further comprising:
computer usable program code for performing the operation of each power supply unit while switching between selected two power supply units at a predetermined timing when the operation of one power supply unit is performed.
